(19) United States
(12) Patent Application Publication
(10) Pub. No.: US 2014/0009395 A1
(43) Pub. Date: Jan. 9, 2014

(54) METHOD AND SYSTEM FOR CONTROLLING EYE TRACKING

(71) Applicant: AsusTeK Computer Inc., Peitou (TW)

(72) Inventors: Calvin Wing-Hang KU, Peitou, Taipei, (TW); Wei-Wen LUO, Peitou, Taipei, (TW); Wen-Chieh TSENG, Peitou, Taipei, (TW)

(21) Appl. No.: 13/922,609

(22) Filed: Jun. 20, 2013

Related U.S. Application Data
(60) Provisional application No. 61/668,184, filed on Jul. 5, 2012.

(30) Foreign Application Priority Data
May 8, 2013 (TW) 102116358

(51) Int. Cl. G06F 3/01

(52) U.S. Cl. CPC G06F 3/013
USPC 345/157

(57) ABSTRACT

A method for controlling an eye tracking applied to an electronic display device which includes a display screen and executes at least one application program is provided. The method includes at least the following steps: enabling an eye tracking control mode; capturing an eye image via an eye tracking detection unit and generating eye position information; receiving the eye position information via an analysis unit and mapping the eye position information to the display screen to generate analysis information; receiving the analysis information via a processing unit and generating an eye tracking cursor according to the analysis information, wherein the processing unit generates a preview window on the display screen according to a position of the application program corresponding to the eye tracking cursor.

### CROSS-REFERENCE TO RELATED APPLICATION

This application claims the priority benefit of U.S. provisional application Ser. No. 61/668,184, filed on Jul. 5, 2012, and Patent Application No. 102116358 filed in Taiwan, Republic of China on May 8, 2013. The entirety of the above-mentioned patent application is hereby incorporated by reference herein and made a part of specification.

### BACKGROUND OF THE INVENTION

1. Field of the Invention

The invention relates to a method and a system for controlling an eye tracking.

2. Description of the Related Art

With the improvement of miniaturization and portability of electronic products, it gradually becomes mature to use a smart phone, a tablet computer or a notebook to browse webpages, read an electronic document, watch a film or application of a personal digital assistant (PDA).

In general, instructions of an electronic display device are controlled by a keyboard, a mouse or a touch control component. When browsing the electronic files, a reading position of a user or a desired control item is speculated according to the position of a cursor. In other words, after user eyes are focused on the control item, it also need the keyboard, the mouse or the touch control component to control the control item, which is really not an intuitive and fast control method.

### BRIEF SUMMARY OF THE INVENTION

A method and a system for controlling an eye tracking to meet requirements are provided.

In an embodiment of the invention, a method for controlling an eye tracking applied to an electronic display device which includes a display screen and executes at least one application program is provided. The method includes at least the following steps: enabling an eye tracking control mode; capturing an eye image via an eye tracking detection unit and generating eye position information; receiving the eye position information via an analysis unit and mapping the eye position information to the display screen to generate analysis information; receiving the analysis information via a processing unit and generating an eye tracking cursor according to the analysis information, wherein the processing unit generates a preview window on the display screen according to a position of the application program corresponding to the eye tracking cursor.

In an embodiment of the invention, a system for controlling an eye tracking applied to an electronic display device which includes a display screen and executes at least one application program is provided. The system includes at least includes: an eye tracking detection unit, an analysis unit and a processing unit. The eye tracking detection unit is disposed at a side of the display screen. The analysis unit is electrically connected to the eye tracking detection unit and the processing unit is electrically connected to the analysis unit. The eye tracking detection unit provides an eye position to the analysis unit. The analysis unit maps the eye position information to the display screen and provides the analysis information to the processing unit. The processing unit generates an eye tracking cursor on the display screen according to the analysis information and the processing unit generates a preview window on the display screen according to a position of the application program corresponding to the eye tracking cursor.

### BRIEF DESCRIPTION OF THE DRAWINGS

FIG. 1 is a flow chart showing a method for controlling an eye tracking in an embodiment;

FIG. 2 is a schematic diagram showing that an eye tracking cursor is generated at an electronic display device according to a method for controlling an eye tracking in an embodiment;

FIG. 3 is an operating schematic diagram showing a method for controlling an eye tracking applied to an electronic display device;

FIG. 4 is a schematic view showing a display image of an electronic display device after executing a control function of a control item in FIG. 3 in an embodiment;

FIG. 5 is a schematic diagram showing a method for controlling an eye tracking applied to an electronic display device and a display screen generates a preview window in an embodiment; and

FIG. 6 is a block diagram showing a system for controlling an eye tracking in an embodiment.

### DETAILED DESCRIPTION OF THE EMBODIMENTS

A method and a system for controlling an eye tracking and their application are illustrated with relating figures, and the same symbols denote the same structures, steps and components. In order to facilitate understanding, the structures, the steps and the components not directly related to the invention are omitted. Additionally, the electronic display device described below may be a notebook, a tablet computer (PC), a desktop or a smartphone, which is not limited herein.

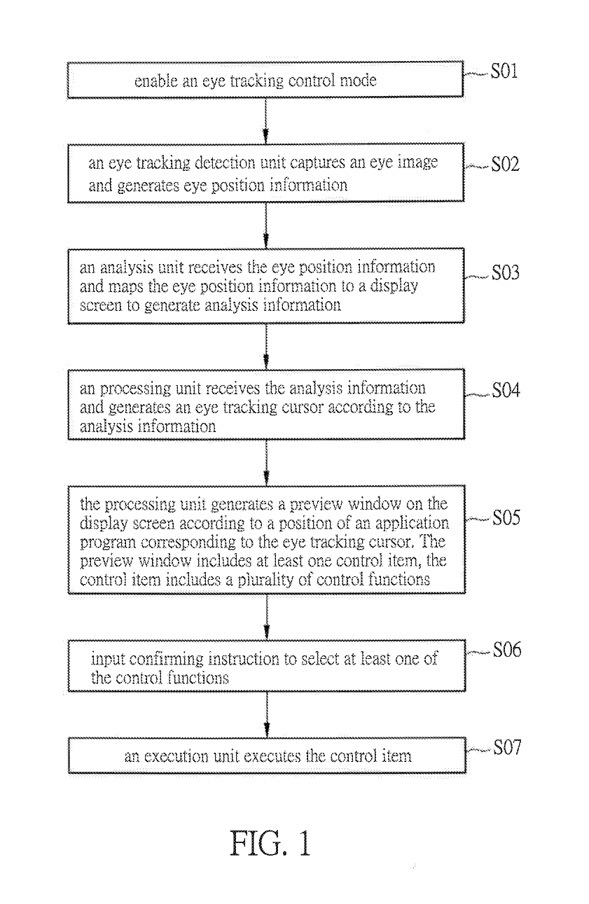

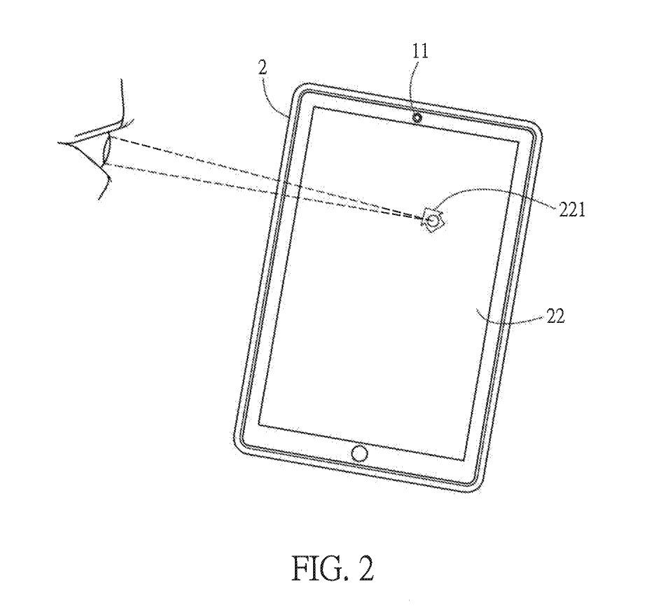

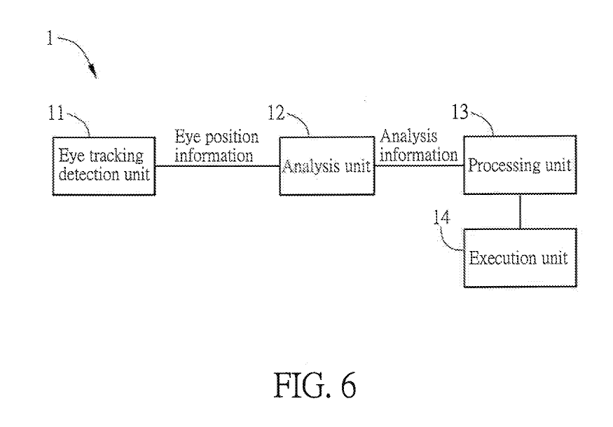

Please refer to FIG. 1, FIG. 2 and FIG. 6, FIG. 1 is a flow chart showing a method for controlling an eye tracking and FIG. 2 is a schematic diagram showing that an eye tracking cursor is generated at an electronic display device according to a method for controlling an eye tracking.

A method for controlling an eye tracking applied to an electronic display device 2 is provided. The electronic display device 2 includes a display screen 22 and executes at least one application program. An eye tracking control system 1 includes an eye tracking detection unit 11.

The method includes at least the following steps: first, an eye tracking control mode is enabled in step S01; the eye tracking detection unit 11 captures an eye image and generates eye position information in step S02. The eye tracking detection unit 11, such as an eye tracking component, enables the eye tracking control mode and generates the eye position information.

The eye tracking detection unit 11 can capture an eye image, an eye coordinate or their combination and transmits them to an analysis unit 12. The eye image is an outline of user eyes, and the eye coordinate is a defined iris by positioning a junction between an iris and a conjunctiva. No matter which of an eye image, an eye coordinate or their combination is captured, it will be converted into an absolute coordinate and transmitted to the analysis unit 12.

Then, the analysis unit 12 receives the eye position information and maps the eye position information to the display screen 22 to generate analysis information in step S03.

The analysis unit 12 receives the eye position information and generates the analysis information. The eye position information may be an eye coordinate of a user. The coordinate captured by the eye tracking detection unit 11 can be mapped to the display screen 22, and the analysis unit 12 can get a focus position of the user sight corresponding to the display screen 22 (such as dotted lines displayed in FIG. 2).

In practical usage, the eye tracking detection unit 11 may constantly detect a movement situation of user eyes. In other words, an eye tracking cursor 221 of the display screen 22 generates a relating motion according to a moving track of the user sight.

Referring to FIG. 2, a processing unit 13 receives the analysis information and generates an eye tracking cursor 221 in step S04. The processing unit 13 controls an application program corresponding to the eye tracking cursor. Detailly speaking, after the processing unit 13 generates an eye tracking cursor 221 on the display screen 22, when a position of the eye tracking cursor 221 moves to a corresponding application program of the display screen, a preview window is generated on the display screen 22 in step S05. The preview window includes at least one control item and the control item further includes a plurality of control functions. Each control function may be corresponding to a different execution function. The preview window may be selected from age information (such as a picture or a screenshot) of the application program in an embodiment.

The application program described above is a general calling for different contents (such as an electronic file, a webpage, or an application software) corresponding to the display screen 22. The application program forms a plurality of control enabling areas, such as a text block, a picture, a shortcut key for enabling a program. Thus, when the eye tracking cursor 221 moves to any application program, the processing unit 13 generates a preview window on the display screen according to a position of the eye tracking cursor 221.

The term “move” in the above sentence represents that the eye tracking cursor 221 moves to a picture of the application program or moves to trigger areas around the picture of the application program to make the processing unit 13 analyze an object which needs to be controlled. The shape of the eye tracking cursor 221 is not limited to the arrow shape in FIG. 2, in other embodiments, the eye tracking cursor 221 is a light spot, or a shape of the entity eye tracking cursor 221 is not displayed on the display screen 22.

Additionally, the method further includes: inputting a confirming instruction to select at least one control function in step S06. The confirming instruction may be that the eye tracking cursor 221 stays on the application program more than a preset time, blinking eyes several times, or the eye tracking cursor 221 moves to a control function of the control item cooperating with some touch gestures. The processing unit 13 transmits a confirming signal to an execution unit 14 to enable at least one control function of the control item.

Additionally, the method may further include executing the control item via the execution unit 14 in step S07.

The method for controlling an eye tracking applied to an electronic display device in an embodiment is illustrated below.

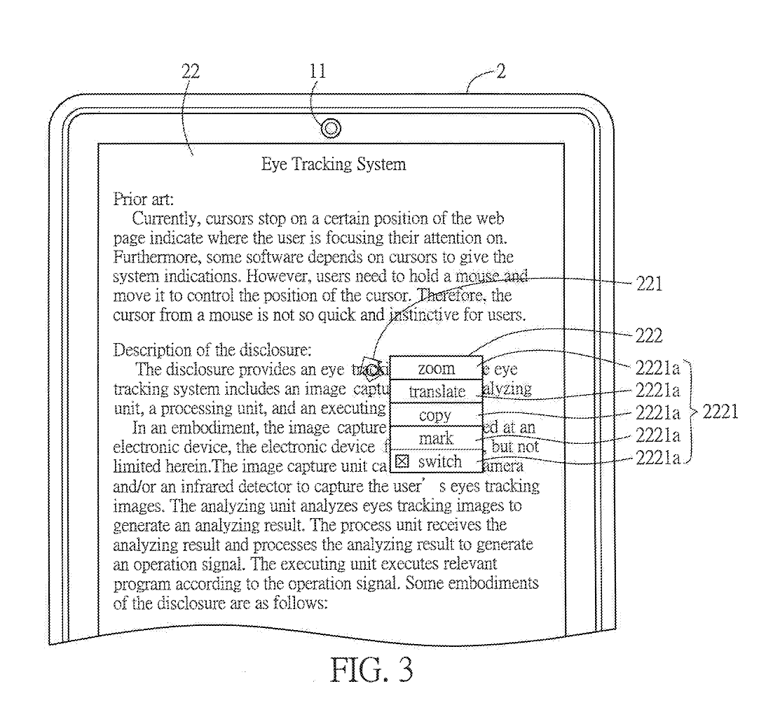

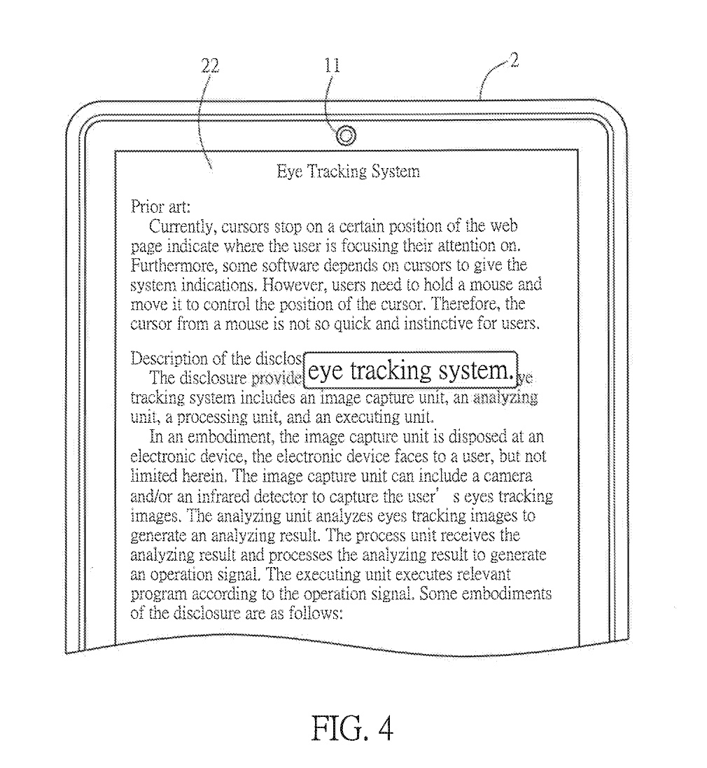

Please refer to FIG. 3 and FIG. 4, FIG. 3 is an operating schematic diagram showing a method for controlling an eye tracking applied to an electronic display device. FIG. 4 is a schematic view showing a display image of an electronic display device after executing a control function of a control item in FIG. 3.

If the user reads a webpage or an electronic file via the electronic display device, the display screen 22 displays the electronic file or the webpage. The electronic file or the webpage includes at least one text area, and each text area is corresponding to an application program. The text area may be a paragraph, a sentence or a word. In other words, the paragraph, the sentence or the word can be set as an enabling area of the application program. Thus, when the eye tracking cursor 221 moves to a position of the corresponding application program, the processing unit generates a preview window 222 according to the position of the eye tracking cursor 221. The preview window 222 includes at least one control item 2221, and the control item 2221 may further include a plurality of control functions 2221a to control the application program at corresponding position.

In the above embodiment, one preview window 222 includes one control item 2221, and the control item 2221 includes five control functions, the invention is not limited thereto.

Detailly speaking, the control function 2221a may be one or a combination of copying words at the application program (text area), zooming words at the application program (text area), translating words at the application program (text area), marking words at the application program (text area), opening or closing electronic files of the application program, which is not limited herein. In other embodiments, the control function 2221a of the control item 2221 further includes a control function for reading text area or mailing via an E-mail.

When the eye tracking cursor 221 moves to a position of a corresponding application program or nearby, a preview window 222 for simply controlling instructions corresponding to the application program is jumped out, such as copying, zooming, translating, marking, or switching, which is not limited herein. The user can intuitively move the eye tracking cursor 221 to a desired control function 2221a to execute the application program. In FIG. 4, the processing unit 13 and the execution unit 14 enable and execute the function of zooming words of the application program (text area).

The control function 2221a of marking words of the application program (text area) can be used to highlight important paragraphs, sentences, words in order to facilitate finding the specific paragraphs, sentences and words next time fast when reading.

Although a plurality of control instructions are displayed in this embodiment, the user also can adjust to a reading mode, and the control item 2221 of the eye tracking cursor 221 only has a control function 2221a (such as the translating function). When the user reads, words selected by the eye tracking cursor 221 is translated directly to meet the user reading habits, and it does not need to additionally select a desired executing action.

Furthermore, in order to provide better reading experience, when the eye tracking cursor 221 moves to the control function 2221a of the control item of the preview window 222, it can set that the control function 2221a is enabled when the eye tracking cursor 221 stays more than preview time or eyes blink twice continuously, so as to avoid that an application program is executed needlessly and affects reading. In other embodiments, the control method of the eye tracking cursor 221 also may cooperate with a touch gesture to enable the application program, which is not limited herein. In another embodiment, right words can be selected via the eye tracking cursor when the user inputs.

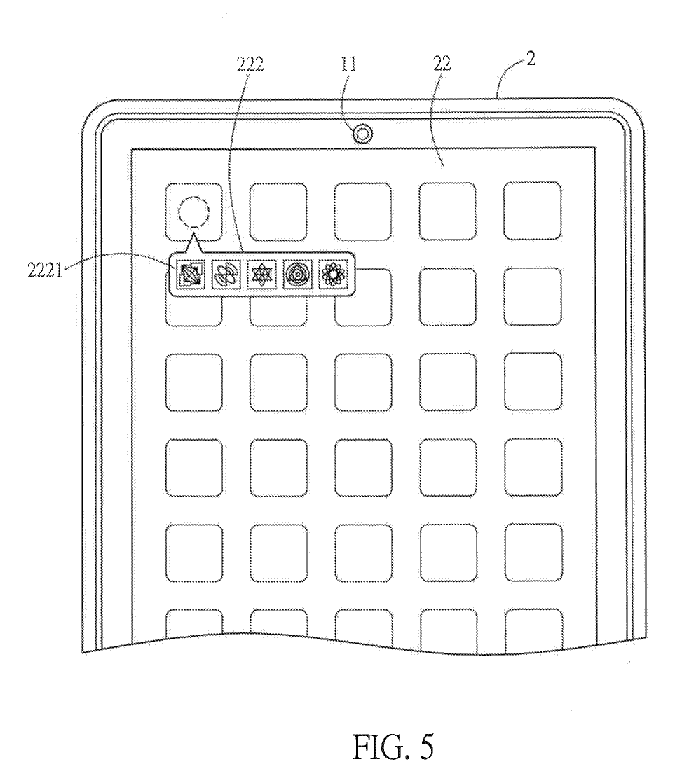

FIG. 5 is a schematic diagram showing a method for controlling an eye tracking applied to an electronic display device and a display screen generates a preview window.

In this embodiment, the display screen 22 of the electronic display device 2 includes at least a plurality of application programs corresponding to different pictures, respectively. The difference between this and above embodiment is that the method further includes the step that the display screen 22 generates a preview window 222 corresponding to a position of the eye tracking cursor when the eye tracking cursor (not shown) moves to the application program.

For example, if the application program is an album folder, when the eye tracking cursor moves to the application program, photo thumbnails at the album folder are generated to form a preview window 222. In other words, the control item in this embodiment is pictures (such as photo thumbnails), which is different from the control item which is a menu in above embodiment. The user can move the eye tracking cursor to any picture to enable a control function, such as opening a picture or playing folder pictures. Or, if the application program is a film, when the eye tracking cursor moves to the application program, a screenshot of the film is generated to form a preview window 222.

Please refer to FIG. 2 and FIG. 6, and FIG. 6 is a block diagram showing a system for controlling an eye tracking.

A system 1 for controlling an eye tracking is applied to an electronic display device 2 which includes a display screen 22. The system 1 includes at least an eye tracking detection unit 11, an analysis unit 12 and a processing unit 13. The eye tracking detection unit 11 is disposed at a side of the display screen 22. The analysis unit 12 is electrically connected to the eye tracking detection unit 11, and the processing unit 13 is electrically connected to the analysis unit 12.

The eye tracking detection unit 11 provides an eye position information to the analysis unit 12. The analysis unit 12 maps the eye position information to the display screen 22 and provides analysis information to the processing unit 13. The processing unit generates an eye tracking cursor 221 according to the analysis information.

The analysis unit 12 receives the eye position information and generates an analysis information according to the eye position information. The eye position information may be an eve coordinate of the user. A coordinate captured by the eye tracking detection unit is mapped to the display screen 22. The analysis unit 12 can get the user sight focus position on the display screen 22.

Additionally, the system 1 further includes an execution unit 14 which is used to execute an application program. The execution unit 14 is electrically connected to the processing unit 13.

Although the processing unit 13 and the execution unit 14 in this embodiment are independent units and structures, they are also may be integrated at a single chip to achieve the same effect in this embodiment.

The other structures and the connection relationships between the units in this embodiment are same to these in the first embodiment, which is omitted herein.

In conclusion, a method and a system for controlling an eye tracking are provided. An eye tracking detection unit is used to capture an eye image, and an eye tracking cursor is generated on the display screen in accordance with an analysis unit and a processing unit. A preview window is generated via an eye tracking cursor corresponding to a position of an application program, and a needed executing control function of the control item is selected from the preview window to directly control the electronic display device via the eye tracking cursor.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A method for controlling an eye tracking, applied to an electronic display device which includes a display screen and executes at least one application program, the method comprising:
enabling an eye tracking control mode;
capturing an eye image via an eye tracking detection unit and generating eye position information;
receiving the eye position information via an analysis unit and mapping the eye position information to the display screen to generate analysis information; and
receiving the analysis information via a processing unit and generating an eye tracking cursor according to the analysis information, wherein the processing unit generates a preview window on the display screen according to a position of the application program corresponding to the eye tracking cursor.

2. The method for controlling the eye tracking according to claim 1, wherein the preview window is selected from image information of the application program.

3. The method for controlling the eye tracking according to claim 1, wherein the preview window includes at least one control item.

4. The method for controlling the eye tracking according to claim 3, further including:
executing the control item via an execution unit.

5. The method for controlling the eye tracking according to claim 3, wherein the control item includes a plurality of control functions, and the control functions include one or a combination of copying, zooming, translating, marking words of the application program, opening or closing electronic files of the application program.

6. The method for controlling the eye tracking according to claim 3, wherein the control item is an image or a menu.

7. The method for controlling the eye tracking according to claim 5, further including:
inputting a confirming instruction to select at least one of the control functions.

8. A system for controlling an eye tracking, applied to an electronic display device which includes a display screen and executes at least one application program, comprising:
an eye tracking detection unit disposed at a side of the display screen;
an analysis unit electrically connected to the eye tracking detection unit; and
a processing unit electrically connected to the analysis unit;
wherein the eye tracking detection unit provides eye position information to the analysis unit, the analysis unit maps the eye position information to the display screen and provides analysis information to the processing unit, the processing unit generates an eye tracking cursor on the display screen according to the analysis information, the processing unit generates a preview window on the display screen according to a position of the application program corresponding to an eye tracking cursor.

9. The system for controlling the eye tracking according to claim 8, wherein the preview window is selected from image information of the application program.

10. The system for controlling the eye tracking according to claim 8, wherein the preview window includes at least one control item.

11. The system for controlling the eye tracking according to claim 10, further including:
an execution unit electrically connected to the processing unit and executing the control item.

12. The system for controlling the eye tracking according to claim 10, wherein the control item includes a plurality of control functions, and the control functions include one or a combination of copying, zooming, translating, marking words of the application program, opening or closing electronic files of the application program.

13. The system for controlling the eye tracking according to claim 10, wherein the control item is an image or a menu.

14. The system for controlling the eye tracking according to claim 8, wherein the electronic display device is a smart phone, a desktop computer, a tablet computer, or a notebook.
